(19) United States
(12) Patent Application Publication
(10) Pub. No.: US 2025/0346035 A1
(43) Pub. Date: Nov. 13, 2025

(54) INK CONTAINER AND LIQUID EJECTION APPARATUS

(71) Applicant: CANON KABUSHIKI KAISHA, Tokyo (JP)

(72) Inventor: RYOHEI YAMADA, Kanagawa (JP)

(21) Appl. No.: 19/196,329

(22) Filed: May 1, 2025

(30) Foreign Application Priority Data
May 8, 2024 (JP) 2024-075691

(51) Int. Cl. B41J 2/175

(52) U.S. Cl. CPC B41J 2/175

(57) ABSTRACT

Provided are an ink container and a liquid ejection apparatus capable of reducing leakage during ink refill. They may contribute to achieving a sustainable society such as a decarbonized/recycling society. To this end, a pouch 20 is supported and held by a support member 24. This enables reduction in plastic usage and possibly contributes to achieving a sustainable society such as a decarbonized/recycling society.

### BACKGROUND

### Field

The present disclosure relates to an ink housing body capable of refilling a tank provided in a liquid ejection apparatus with ink and also to the liquid ejection apparatus.

### Description of the Related Art

Japanese Patent Laid-Open No. 2022-164023 discloses an inkjet printer configured such that a refill container housing ink is connected to an ink tank capable of housing ink with the refill container being upright and having its opening portion facing down.

Meanwhile, with global moves to plastic reduction accelerating in recent years, there have been demands for replacing plastic materials or using them less for inkjet printers and printer industrial chemicals including ink bottles.

Replacing refill containers with pouches can reduce plastic material usage. In a case where a pouch replaces a refill container, refill is performed with a spout portion of the pouch being fixed to a spout fixation portion of the ink tank, like in Japanese Patent Laid-Open No. 2022-164023. However, in a case where a pouch is used in place of a refill container, the pouch is, compared to the refill container, soft and unstable in terms of its behavior (posture) during ink refill. Thus, the pouch may fall over during refill, in which case the spout portion of the pouch may come off from the spout fixation portion of the ink tank, possibly resulting in ink leakage. Also, by bending upon falling over, the pouch may break, resulting in ink leakage.

### SUMMARY

Thus, the present disclosure provides an ink container and a liquid ejection apparatus capable of reducing leakage during ink refill.

To this end, an ink container of the present disclosure includes: an ink storing bag configured to store ink; a spout for supplying the ink housed in the bag body to an external tank; and a support member having a support portion that supports the ink storing bag in such a manner that the ink storing bag maintains posture and an engagement portion for maintaining connection between the ink container and the tank via the spout.

The present disclosure can provide an ink container and a liquid ejection apparatus capable of reducing leakage during ink refill.

Further features of the present disclosure will become apparent from the following description of exemplary embodiments with reference to the attached drawings.

### BRIEF DESCRIPTION OF THE DRAWINGS

FIG. 1 is a schematic diagram showing the primary part of a liquid ejection apparatus;

FIGS. 2A, 2B, 2C, and 2D are diagrams showing an example of a liquid container having a pouch inserted in a support member;

FIGS. 3A and 3B are diagrams showing an ink supply unit of the liquid ejection apparatus to which the support member is attached;

FIG. 4 is a diagram showing an example of a liquid container having a pouch inserted in a support member;

FIG. 5 is a diagram showing the ink supply unit of the liquid ejection apparatus to which the support member is attached;

FIGS. 6A and 6B are diagrams showing how liquid housing bodies are connected to corresponding ink supply units;

FIGS. 7A and 7B are diagrams showing a liquid container; and

FIG. 8 is a diagram showing a liquid container and a liquid ejection apparatus.

### DESCRIPTION OF THE EMBODIMENTS

A first embodiment of the present disclosure is described below with reference to the drawings.

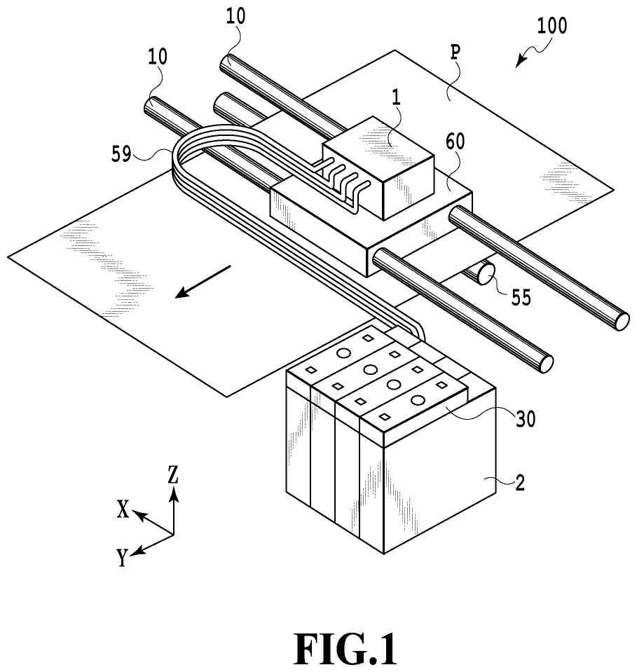

FIG. 1 is a schematic diagram showing the principal part of a liquid ejection apparatus 100. A schematic configuration of the liquid ejection apparatus 100 of the present embodiment is described with reference to FIG. 1. The liquid ejection apparatus 100 of the present embodiment is a serial-type inkjet printing apparatus configured to print on a print medium P by ejecting liquid, namely ink, while scanning a liquid ejection head (ejection unit) 1.

The liquid ejection head 1 is mounted on a carriage 60. The carriage 60 reciprocates in a main scanning direction (an X-direction) along a guide shaft 10. The print medium P is conveyed by a conveyance roller 55 in a sub scanning direction (a Y-direction) intersecting with (in this example, orthogonal to) the main scanning direction. Throughout the drawings to which references are made hereinbelow, a Z-direction represents a vertical direction and intersects with (or is, in this example, orthogonal to) a XY-plane defined by the X-direction and the Y-direction. The liquid ejection head 1 is configured so that a user can detach and attach the liquid ejection head 1 from and to the carriage 60.

The liquid ejection apparatus 100 is provided with an ink tank 2, which is an ink supply source, and a pump (not shown). With the driving force produced by the pump, ink stored in the ink tank 2 is supplied to the liquid ejection head 1 through an ink supply tube 59. An ink supply unit 30 is provided at an upper portion of the ink tank 2. Details of the ink supply unit 30 will be described later.

The liquid ejection apparatus 100 forms a predetermined image on the print medium P by repeating a print/scan operation and a conveyance operation. In the print/scan operation, the liquid ejection head 1 mounted on the carriage 60 ejects and prints ink while moving in the main scanning direction, and in the conveyance operation, the print medium P is conveyed in the sub scanning direction. Note that the liquid ejection head 1 of the present embodiment can eject four types of ink: black (K), cyan (C), magenta (M), and yellow (Y) and can print a full-color image using these inks. It should be noted, however, that the inks that the liquid ejection head 1 can eject are not limited to the four types of ink mentioned above. The present disclosure can also be applied to liquid ejection heads that eject other types of ink. In other words, there are no limitations as to the types of ink and the number of types of ink ejected by the liquid ejection head 1.

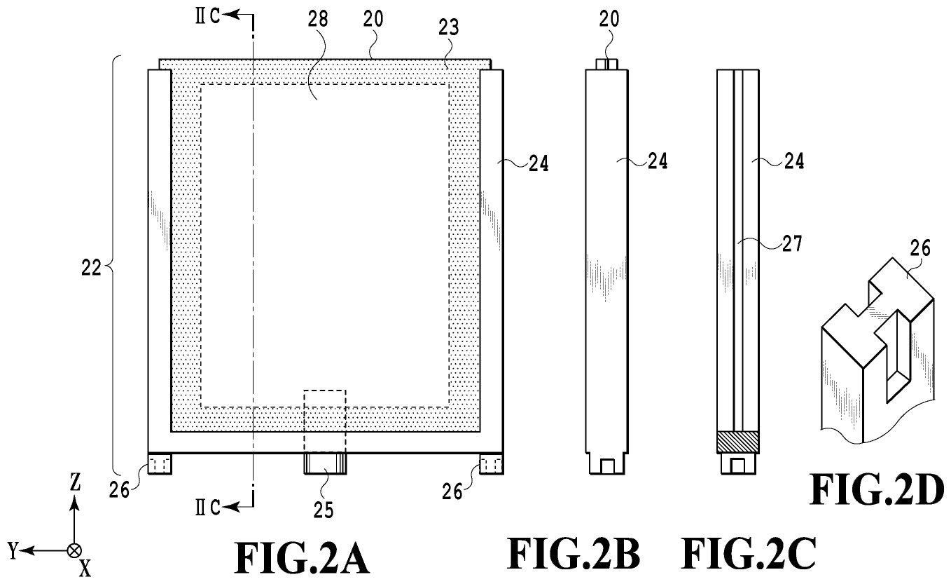

FIGS. 2A to 2D are diagrams showing an example of an ink container (hereinafter also referred to as a liquid container) 22 having a pouch (an ink storing bag) 20, which is a refill pack (a bag body), inserted in a support member 24 in the present embodiment. The X, Y, and Z axes in FIG. 2A represent directions for a state where the liquid container 22 attached to the ink supply unit 30. FIG. 2A is a side view, FIG. 2B is a front view of the support member 24, and FIG. 2C is a view of the support member 24 as seen from IIc-IIc in FIG. 2A (without the pouch 20). FIG. 2D is a diagram showing an engagement portion 26. The liquid container 22 includes the pouch 20, a spout 25, a side sealed portion 23, and the support member 24. The liquid container 22 is configured to be able to connect with the external ink tank 2.

The pouch 20 is formed by a front body part and a rear body part, and these parts are each made of a laminate of a plastic film as a base material and a heat-sealable layer. The side sealed portion 23 (an edge portion) surrounding a body portion 28 capable of housing liquid is heat-sealed. The spout (opening portion) 25, which is a liquid spout of the pouch 20, is tubular and is thermally welded between the front body part and the rear body part of the pouch 20. Ink can be poured into the pouch 20 through the spout 25, and the ink inside the pouch can be supplied to the liquid ejection apparatus 100.

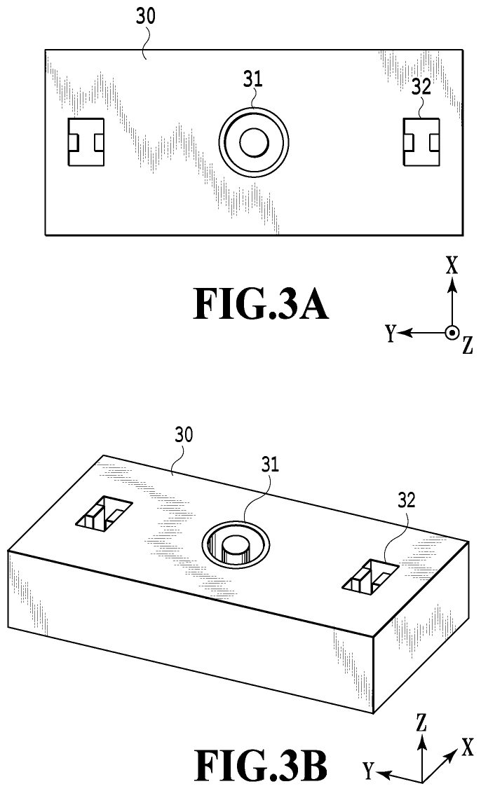

The support member 24 is U-shaped and has the pouch 20 inserted thereinside in a longitudinal direction (the −Z-direction in the drawings). Note that the −Z-direction is the direction of gravitational force because the X, Y, and Z axes in FIGS. 2A to 2D represent directions for a state where the liquid container 22 is attached to the ink supply unit 30 as mentioned above. However, it is a direction in which the pouch 20 is inserted into the support member 24 in FIGS. 2A to 2D, and the pouch 20 does not have to be inserted in the direction of gravitational force. In other words, in FIGS. 2A to 2D, the Z-direction may be, for example, the horizontal direction. The support member 24 prevents the pouch 20 from bending and maintains the liquid-housing posture of the pouch 20 irrespective of whether there is liquid inside the pouch 20. With the pouch 20 inserted in the support member 24, the spout 25 of the pouch 20 penetrates through a through-hole provided at the support member 24, and the tip end portion of the spout 25 protrudes to the outside of the member. The liquid container 22 is a state where the support member 24 supports the pouch 20. To attach the liquid container 22 to the liquid ejection apparatus 100, with the spout 25 facing down, the liquid container 22 is moved in the direction of gravitational force and attached to the ink supply unit 30 of the liquid ejection apparatus 100 (see FIG. 3A to be referred to later). A groove 27 is formed in the inner frame of the support member 24. The edge portion of the side sealed portion 23 of the pouch 20 engages with the groove 27. To attach the pouch 20 to the support member 24, the pouch 20 is inserted into the support member 24 in the −Z-direction from the spout 25 side, with the edge portion of the side sealed portion 23 sliding in the groove 27. To detach the pouch 20 from the support member 24, the pouch 20 is slid out of the support member 24 in an opposite direction (the Z-direction) from the insertion direction. In the present embodiment, as shown in FIG. 2A, two support columns of the support member 24 support the respective opposing sides of the pouch 20.

The pouch 20 may be held onto the support member 24 with a simple configuration. For example, the spout 25 may be fixed to the support member 24 while being retained not to come off using a C-ring, an E-ring, or the like. Also, the pouch 20 may be bonded or welded in place to the support member 24.

The pouch 20 and the support member 24 can be used repeatedly: the pouch 20 can be cleaned after use and reused, and the support member 24 can be reused after the pouch 20 is removed. In this case, the support member 24 supports the pouch 20 detachably. Note that in a case where the pouch 20 is bonded or welded in place to the support member 24, the pouch 20 is not reusable.

The support member 24 includes the engagement portions 26, which are portion of the support columns protruding in the −Z-direction. The engagement portions 26 are provided in such a manner as to protrude in the direction of the axis of the tubular spout 25. The engagement portion 26 are H-shaped in cross section and fit into the ink supply unit 30 (see FIGS. 3A and 3B to be referred to later) of the liquid ejection apparatus 100. The engagement between the engagement portions 26 and the ink supply unit 30 (see FIGS. 3A and 3B to be referred to later) enables the ink tank 2 and the spout 25 of the pouch 20 to be connected and can maintain the connection between the ink tank 2 and the pouch 20.

The support member 24 is depicted having substantially the same length as the pouch 20 in the Z-direction in FIGS. 2A to 2D, but only needs to be at least half as long as the pouch 20 in the Z-direction.

FIGS. 3A and 3B are diagrams showing the ink supply unit (a supply unit) 30 of the liquid ejection apparatus 100 to which to attach the support member 24. FIG. 3A is a top view, and FIG. 3B is a perspective view. As described earlier, the ink supply unit 30 is provided at an upper portion of the ink tank 2 (see FIG. 1) of the liquid ejection apparatus 100 in terms of the direction of gravitational force. The ink supply unit 30 has two engagement counterpart portions 32 which fit around the respective engagement portions 26 of the support member 24. Also, an ink supply port 31 fits into the spout 25 of the pouch 20. In the present embodiment, the engagement counterpart portions 32 are disposed at positions symmetrical with respect to the ink supply port 31 serving as a center point. As shown in FIG. 2A, the engagement portions 26 protrude in the direction of the axis of the tubular spout 25 and protrude beyond the opening portion of the spout 25. Thus, the engagement counterpart portions 32 and the engagement portions 26 engage with each other before the ink supply port 31 fits into the spout 25 of the pouch 20. Alternatively, the engagement configuration for the engagement counterpart portions 32 and the engagement portions 26 may be such that, with the engagement counterpart portions 32 protruding, the engagement portions 26 receive the protruding engagement counterpart portions 32.

In the present embodiment, to refill the liquid ejection apparatus 100 with ink, the support member 24 is moved and connected to the ink supply unit 30 of the liquid ejection apparatus 100 in the direction of gravitational force (the −Z-direction in the drawings). By the connection of the support member 24, the spout 25 is connected to the ink supply port 31, and the engagement portions 26 of the support columns are connected to the engagement counterpart portions 32. In this way, the liquid ejection apparatus 100 of the present embodiment can supply ink from the inside of the pouch 20 to the ink tank 2 of the liquid ejection apparatus 100 after the support member 24 is fit into the ink supply unit 30 with the spout 25 being connected to the ink supply port 31 without any gap therebetween. Ink can be supplied to the ink tank 2 while the liquid ejection apparatus 100 is in operation too. It is expected that the liquid ejection apparatus 100 vibrates while the liquid ejection apparatus 100 is in operation. However, because both edges of the pouch 20, namely the side sealed portion 23, are secured by the support member 24, the pouch 20 can maintain its posture and does not fall over, which makes it possible to maintain the connection.

In this way, the pouch 20 is supported and held by the support member 24. This makes it possible to provide an ink container and a liquid ejection apparatus capable of reducing leakage during ink refill. Also, the present disclosure can be favorably applied even to the liquid ejection apparatus 100 configured to print on a print medium with the ink container 22 being connected. Even in such a case, the connection and posture of the ink container 22 and the pouch 20 are maintained during printing. Also, even with the liquid ejection apparatus 100 configured to eject ink with the ink container being exposed from the housing of the liquid ejection apparatus 100, the connection and posture of the ink container 22 and the pouch 20 are maintained during printing.

### Second Embodiment

A second embodiment of the present disclosure is described below with reference to the drawings. Because the present embodiment has the same basic configuration as the first embodiment, only characteristic configurations are described below.

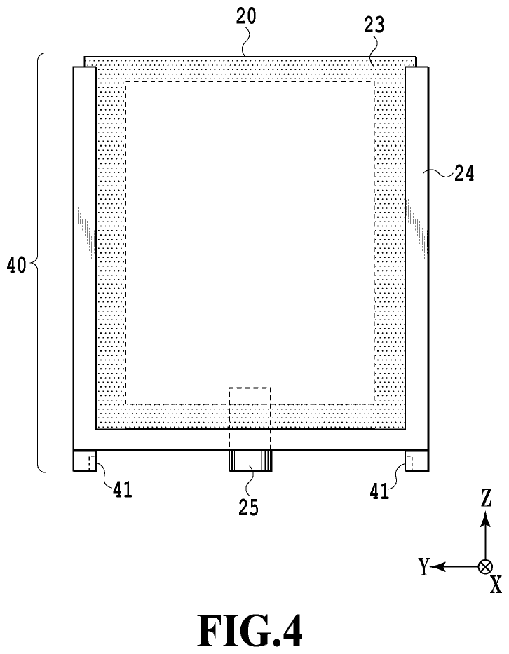

FIG. 4 is a diagram showing an example of a liquid container 40 having the pouch 20 inserted in the support member 24 in the present embodiment. The support member 24 of the liquid container 40 has engagement portions 41, and the engagement portions 41 each have a cross-sectional shape corresponding to the type of liquid housed in the pouch 20.

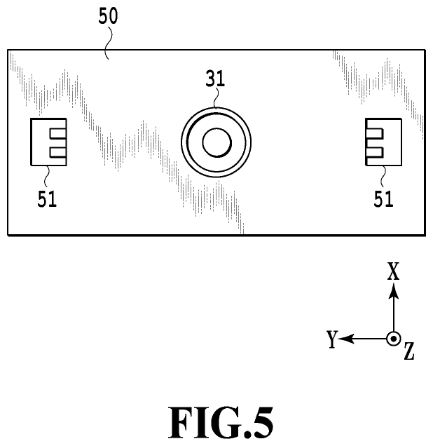

FIG. 5 is a diagram showing an ink supply unit 50 of the liquid ejection apparatus 100 to which to attach the support member 24 in the present embodiment. The ink supply unit 50 has engagement counterpart portions 51 having a shape corresponding to the type of liquid housed in the ink tank 2 (see FIG. 1) to which the ink supply unit 50 is attached. The shape of the engagement counterpart portions 51 conforms to the sectional shape of the engagement portions 41 of the corresponding liquid container 22 so that only the liquid container 22 for the corresponding type of liquid can be connected thereto. This prevents connection to liquid of a different type from the liquid in the ink tank 2.

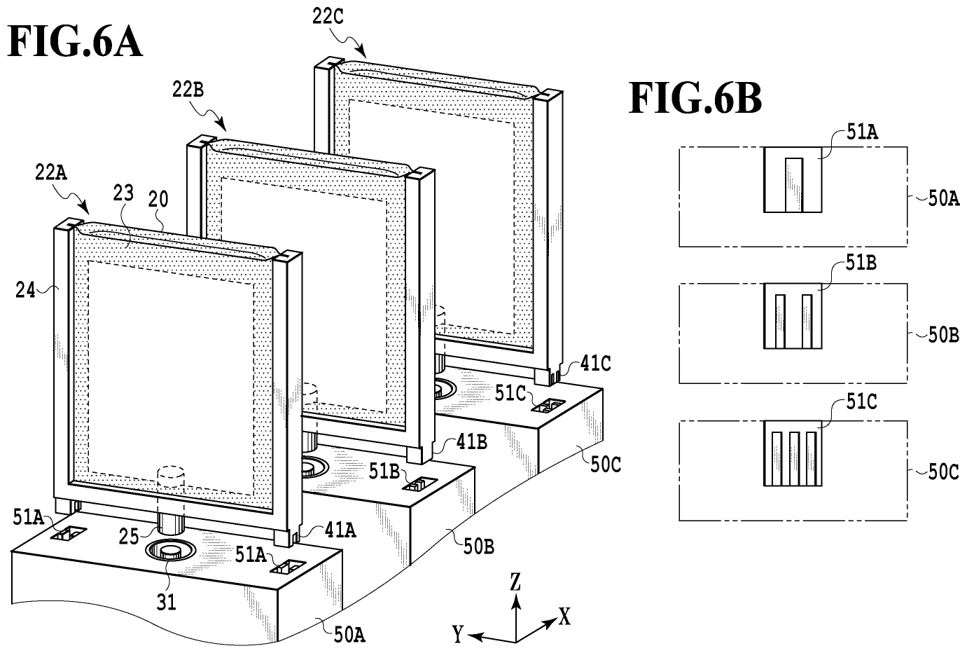

FIG. 6A is a diagram showing how liquid housing bodies 22A, 22B, and 22C housing different types of liquid are connected to the corresponding ink supply units 50A, 50B, and 50C, respectively, and FIG. 6B is a cross-sectional view showing engagement counterpart portions 51A, 51B, and 51C. In FIG. 6A, the cross-sectional shape of engagement portions 41A and the engagement counterpart portions 51A conform to each other, the cross-sectional shape of the engagement portions 41B and the engagement counterpart portions 51B conform to each other, and the cross-sectional shape of the engagement portions 41C and the engagement counterpart portions 51C conform to each other. In other words, for example, the liquid container 22A cannot be connected to the engagement counterpart portions 51C because the cross-sectional shape of the engagement portions 41A does not conform to the engagement counterpart portions 51C.

Although FIGS. 6A and 6B show a case of supporting three types of liquid as an example, the present disclosure is not limited to supporting three types, and it is desirable to increase or decrease the number of units in accordance with the types of liquid used in the liquid ejection apparatus.

In this way, the shape for engagement between the support member 24 and the ink supply unit 50 is differentiated depending on the type of ink, so that erroneous insertion of liquid can be prevented.

### Third Embodiment

A third embodiment of the present disclosure is described below with reference to the drawings. Note that because the present embodiment has the same basic configuration as the first embodiment, only characteristic configurations are described below.

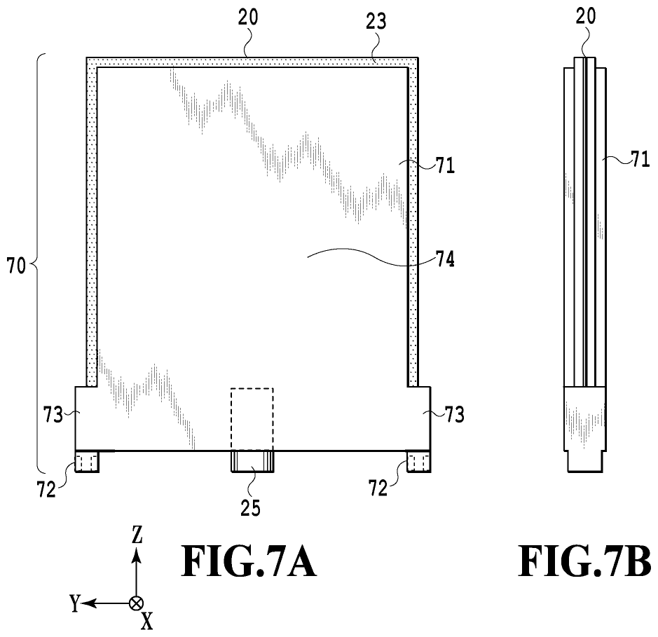

FIGS. 7A and 7B are diagrams showing a liquid container 70 in the present embodiment. The liquid container 70 of the present embodiment includes a support member 71 having support surfaces 74 supporting the flat portion (front and rear surfaces) of the pouch 20. The pouch 20 accommodated in the liquid container 70 is supported in such a manner as to be sandwiched by the support surfaces 74 of the support member 71. In other words, the support surfaces 74 support the plastic film surfaces of the pouch 20 at the front and the back. The width of the support surfaces 74 in the Y-direction is smaller than the width of the pouch 20 in the Y-direction, and to insert the pouch 20 into the support member 71, a user holds the side sealed portion 23 of the pouch 20 and inserts the pouch 20.

In this way, the flat portion of the pouch 20 is supported by the support member 71. This makes it possible to provide an ink container and a liquid ejection apparatus capable of reducing leakage during ink refill.

### Fourth Embodiment

A fourth embodiment of the present disclosure is described below with reference to the drawings. Because the present embodiment has the same basic configuration as the first embodiment, only characteristic configurations are described below.

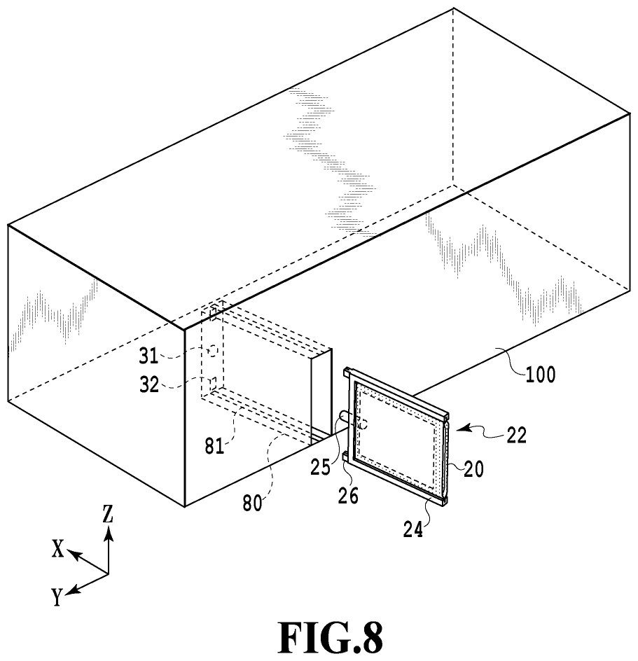

FIG. 8 is a diagram showing the liquid container 22 and the liquid ejection apparatus 100 of the present embodiment. While the above embodiments describe configurations where the liquid container 22, 70 and the ink supply unit 30, 50 are simply connected, the present embodiment describes a configuration where the liquid container 22 is connected to the liquid ejection apparatus 100 by sliding the support member 24 of the liquid container 22. Also, in the present embodiment, the liquid container 22 is slid and inserted to the liquid ejection apparatus 100 in the X-direction, which is different from the direction of gravitational force.

The liquid ejection apparatus 100 includes a storage unit 80 where the liquid container 22 can be stored. The liquid ejection apparatus 100 is connected to the liquid container 22 by having the liquid container 22 stored in the storage unit 80. The storage unit 80 has a guide 81 along which the support column portions of the support member 24 of the liquid container 22 can be slid and inserted. The storage unit 80 is also provided with the engagement counterpart portions 32 engageable with the engagement portions 26, and upon completion of connection between the engagement portions 26 and the engagement counterpart portions 32, connection between the spout 25 and the ink supply port 31 is completed.

There may be a plurality of the storage units 80 in a case where there are a plurality of pouches 20 for respective types of liquid. Also, there may be only one storage unit with a plurality of guides provided inside the storage unit.

In the present embodiment, as described above, the liquid container 22 is slid and connected to the liquid ejection apparatus 100 horizontally. Thus, liquid housed in the liquid container 22 cannot be moved to the ink tank 2 (see FIG. 1) by gravity. For this reason, in the present embodiment, a negative pressure generation unit (not shown), such as a pump, is connected to the ink tank 2 (see FIG. 1) to which to connect the liquid container 22. To refill the ink tank 2 with liquid, the negative generation unit brings the inside of the ink tank to negative pressure to suck the liquid from the liquid container 22 and refill the ink tank 2.

Note that the configuration where the liquid container 22 is slid and stored into the storage unit 80 is not limited to insertion in the X-direction. The liquid container 22 may be slid and inserted in the −Z-direction.

In this way, the spout 25 and the ink supply port 31 may be connected by the storing of the liquid container 22 into the storage unit 80 of the liquid ejection apparatus 100.

The technique described herein may contribute to achieving a sustainable society, such as a decarbonized/recycling society.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-075691 filed May 8, 2024, which is hereby incorporated by reference wherein in its entirety.

What is claimed is:

1. An ink container comprising:
an ink storing bag configured to store ink,
a spout for supplying the ink housed in the bag body to an external tank and
a support member having
a support portion that supports the ink storing bag in such a manner that the ink storing bag maintains posture and
an engagement portion for maintaining connection between the ink container and the tank via the spout.

2. The ink container according to claim 1, wherein
the spout is tubular in shape and penetrates through the support member.

3. The ink container according to claim 1, wherein
the ink storing bag has a sealed portion where edge of stacked plastic films are sealed, and
the support member has a groove with which an edge of the sealed portion engages.

4. The ink container according to claim 1, wherein
the support member supports front and rear surfaces of the ink storing bag.

5. The ink container according to claim 2, wherein
the engagement portion protrudes in a direction of a axial direction of the cylindrical shape of the spout and protrudes beyond an opening portion of the spout.

6. The ink container according to claim 1, wherein
a cross-sectional shape of a tip of the engagement portion is shaped so as to engage with an engagement counterpart portion provided at the tank, and
the cross-sectional shape is a shape corresponding to a type of the ink housed in the ink storing bag.

7. The ink container according to claim 3, wherein
the sealed portion is welded.

8. The ink container according to claim 1, wherein
the support member is plastic.

9. The ink container according to claim 1, wherein
the support member has at least two of the support portions.

10. The ink container according to claim 9, wherein
the two support members support respective two opposing sides of the ink storing bag.

11. The ink container according to claim 1, wherein
the support member supports the ink storing bag in such a manner that the ink storing bag is detachable.

12. A liquid ejection apparatus comprising:
an ink container including an ink storing bag configured to store ink, a spout for supplying the ink housed in the bag body to an external tank and a support member having a support portion that supports the ink storing bag in such a manner that the ink storing bag maintains posture and an engagement portion for maintaining connection between the ink container and the tank via the spout,
a supply unit having an opening portion connectable to the spout and an engagement counterpart portion engageable with the engagement portion;
the tank capable of storing the ink supplied from the ink container via the supply unit; and
an ejection unit capable of ejecting the ink housed in the tank.

13. The liquid ejection apparatus according to claim 12, comprising a storage unit capable of storing the ink container, wherein
with the ink container stored in the storage unit, the ink container and the supply unit are connected to each other.

14. The liquid ejection apparatus according to claim 13, wherein
the storage unit has a guide along which the support member of the ink container is slidable and insertable.

15. The liquid ejection apparatus according to claim 12, wherein
the ink container is stored in such a manner that the ink is supplied from the ink container in a direction of gravitational force.

16. The liquid ejection apparatus according to claim 12, wherein
the ink container is stored in such a manner that the ink is supplied from the ink container in a direction intersecting with a direction of gravitational force.

17. The liquid ejection apparatus according to claim 16, comprising:
the tank to which the ink is supplied from the ink container and
a pressure control unit that brings an inside of the tank into negative pressure.

18. The liquid ejection apparatus according to claim 12, wherein
the ink is ejected with the ink container being exposed from a housing of the liquid ejection apparatus.

19. The liquid ejection apparatus according to claim 12, comprising a plurality of the engagement counterpart portions to which to connect a plurality of the ink housing bodies, wherein
the plurality of engagement counterpart portions have different shapes from one another.
